(19) United States
(12) Patent Application Publication
(10) Pub. No.: US 2017/0306884 A1
(43) Pub. Date: Oct. 26, 2017

(54) INTAKE MANIFOLD DUAL PORT SEAL GASKET

(71) Applicant: Ford Global Technologies, LLC, Dearborn, MI (US)

(72) Inventors: Samuel Jeffrey Tomlinson, Farmington Hills, MI (US); Gary Nola, Detroit, MI (US)

(21) Appl. No.: 15/135,049

(22) Filed: Apr. 21, 2016

(51) Int. Cl. F02F 11/00; F02M 35/10; F16J 15/06; F16J 15/10

(52) U.S. Cl. CPC F02F 11/002; F16J 15/102; F02M 35/10144; F16J 15/061

(57) ABSTRACT

A gasket arrangement for use between an intake manifold and a cylinder head of an internal combustion engine is provided. Individual runner grooves are formed around each of the manifold runner openings. A collective runner groove is formed around all of the individual runner grooves. A relatively compressible sealing gasket material is placed in each of the runner grooves and a barrier gasket material placed in the collective runner groove. The relatively compressible sealing gasket material provides an effective seal at low engine operating temperatures. The barrier gasket material provides an effective seal against the passage of hydrocarbons. The relatively compressible sealing gasket material is preferably silicone rubber. The barrier gasket material is preferably a fluorine elastomer having a high fluorine content of preferably at least 66.0%. Accordingly, the silicone gasket provides a seal while the fluorinated polymer gasket is relatively impermeable to hydrocarbons and satisfies emission requirements.

### TECHNICAL FIELD

The disclosed invention relates generally to intake manifold gaskets for internal combustion engines. More particularly, the disclosed inventive concept relates to a gasket arrangement for an intake manifold that includes two gaskets that operate in conjunction with each other, one of which surrounds each intake manifold runner opening and the other of which surrounds all of the runner openings. The gaskets are composed of different and complimentary materials that function effectively when used together.

### BACKGROUND OF THE INVENTION

The sealing of an intake manifold relative to the cylinder head intake port of an internal combustion engine presents certain challenges related to the flow of the air/fuel mixture. Failure of the intake manifold gasket is typically attributed to expansion, contraction and heat generated by combustion. This situation is complicated because the heat to which the gasket is exposed varies during engine operation. Specifically, at engine start-up, the amount of heat generated by the engine is relatively low. The temperature gradually increases as engine on-time continues until its normal operating temperature increases. Even then, the engine is subject to potentially higher heats when subject to load in conditions such as trailer hauling or in extreme ambient conditions.

There are two major requirements of intake manifold port gaskets. The first of these requirements is that the intake manifold gasket must seal in air or the air/fuel mixture travelling from the throttle to the cylinder during all operating conditions. The second requirement is that the intake manifold gasket must prevent permeation of hydrocarbons and possible passage into the atmosphere as required by current emissions control regulations. Achieving both of these requirements can be challenging given the wide variation in engine temperatures.

Earlier gaskets used to form a seal between the intake manifold and the cylinder head of an internal combustion engine were composed of cork. As requirements for effective emission control increased, cork as a seal proved unsatisfactory. Later material provided better emission control but proved unsatisfactory across the wide operating temperature range of the modern internal combustion engine, particularly at the low temperature experienced at engine start-up. In response, engineered materials were developed that are typically used today between the intake manifold and the cylinder head. These materials are not only expensive but nonetheless provide unsatisfactory results at the low initial operating temperature.

In addition, current intake manifold gasket technology that provides a single gasket is subject to structural failure or may fail to comply with existing standards particularly as the gasket is in operation during its service life. Long-term durability and continuous compliance with requirements can be hard to achieve in a single gasket arrangement where the gasket is being called upon to function effectively in both high and low temperature conditions over its entire expected operating life.

As in so many areas of automotive vehicle technology there is always room for improvement related to the use and operation of intake manifold gaskets provided between the intake manifold and the cylinder block of an internal combustion engine.

### SUMMARY OF THE INVENTION

The disclosed inventive concept overcomes the problems of known gasket arrangements for sealing an intake manifold relative to the cylinder head of an internal combustion engine. The disclosed inventive concept particularly provides an effective combination of a relatively low-cost sealing silicone gasket that demonstrates good sealing properties at all engine operating temperatures and a relatively high-cost and a fluorinated polymer gasket that demonstrates good barrier properties at only high operating temperatures. Thus the silicone gasket provides an effective seal at low engine temperatures while the fluorinated polymer gasket provides a relatively impermeable hydrocarbon seal and accordingly satisfies emission requirements.

Particularly, the disclosed inventive concept provides a system for sealing one engine component relative to another. The sealing system finds particular application for sealing a cylinder head and an intake manifold having runner openings, but may also find application for sealing a throttle body and an intake manifold. The system provides an individual runner groove formed around each of the runner openings in the intake manifold forming a plurality of runner grooves and a collective runner groove formed around all of the runner grooves. A relatively compressible sealing gasket material is placed in each of the plurality of runner grooves and a barrier gasket material is placed in the collective runner groove.

The relatively compressible sealing gasket material provides an effective seal against a broad engine operating temperature range, preferably between about −75° C. to about 225° C. The relatively compressible sealing gasket material is preferably rubber, such as silicone rubber, and may be extruded.

While providing an effective seal against a broad temperature range, the sealing gasket material is not as effective in providing a hydrocarbon seal. Accordingly, the outer barrier gasket formed form a non-permeable fluorine elastomer is provided to compensate for the hydrocarbon permeability of the sealing gasket. The barrier gasket has a relatively narrow temperature range of about −25° C. to between about 200° C. and 250° C. Optimally the fluorine elastomer has a high fluorine content such as higher than 66.0%. In addition, it is preferred that the fluorine elastomer is a bisphenol-cured elastomer.

The sealing gasket thus provide an effective seal against a broad temperature range of the engine including a low temperature at a low cost, but is not relied upon for its hydrocarbon barrier properties. Conversely, the barrier gasket is impermeable to hydrocarbons, though it is relatively expensive and is relatively ineffective at providing a seal at low engine operating temperatures. Accordingly, used in conjunction, the sealing gasket and the barrier gasket provide both a good seal across a wide temperature spectrum as well as an effective hydrocarbon barrier. Because only a small amount of the relatively expensive barrier gasket needs to be used in conjunction with the less expensive sealing gasket, the disclosed inventive concept is a low-cost solution to gasket demands.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 shows a perspective view of an intake manifold according to the disclosed inventive concept illustrating the dual intake manifold port gasket in position against the face of the intake manifold according to the disclosed inventive concept; and

FIG. 2 illustrates a sectional view of the dual intake manifold port gasket according to the disclosed inventive concept in its intended engine environment, positioned between a cylinder head intake port and an intake manifold flange, bolted in place.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The figures illustrate the dual intake manifold port gasket arrangement of the disclosed inventive concept as it would appear on the face of the intake manifold and between the intake manifold and the cylinder head intake port. It is to be understood that the components shown are for purposes of illustration only and are not intended as being limiting. For example, the intake illustrated intake manifold shows three runners. However, the intake manifold may have a greater or lesser number of runners without deviating from the spirit of the disclosed inventive concept.

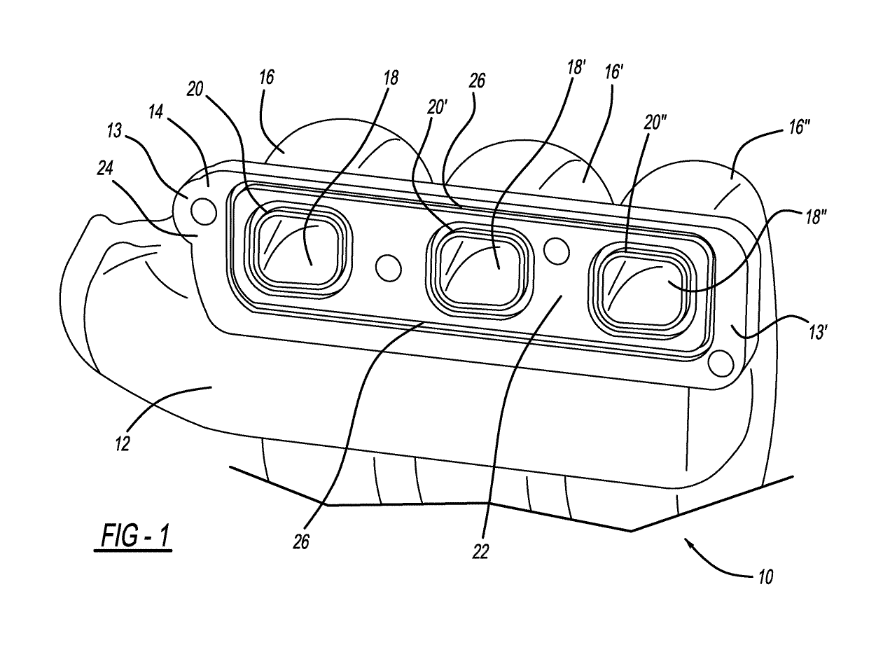

Referring to FIG. 1, a perspective view of an intake manifold according to the disclosed inventive concept is shown illustrating an intake manifold 10 having a manifold body 12 having attachment flanges 13 and 13′. The manifold body 12 may be made of any material suited for such a purpose, including but not limited to, steel, iron, aluminum, and a plastic. An intake manifold face 14 is formed on the manifold body 12. A plurality of intake manifold runners 16, 16′ and 16″ is attached to the intake manifold face 14.

An air-fuel mixture opening 18 is formed at the approximate intersection of the intake manifold runner 16 and the intake manifold face 14. A seal-receiving inner groove 20 is formed in the intake manifold face 14 around the air-fuel mixture opening 18. An air-fuel mixture opening 18′ is formed at the approximate intersection of the intake manifold runner 16′ and the intake manifold face 14. A seal-receiving inner groove 20′ is formed in the intake manifold face 14 around the air-fuel mixture opening 18′. Finally, an air-fuel mixture opening 18″ is formed at the approximate intersection of the intake manifold runner 16″ and the intake manifold face 14. A seal-receiving inner groove 20″ is formed in the intake manifold face 14 around the air-fuel mixture opening 18″.

The intake manifold face 14 includes an inner raised surface 22 and an outer raised surface 24. Between the inner raised surface 22 and the outer raised surface 24 is a seal-receiving outer groove 26. The seal-receiving outer groove 26 encircles the seal-receiving inner grooves 20, 20′ and 20″. The shape and depth of each of the seal-receiving inner grooves 20, 20′ and 20″ and the seal-receiving outer groove 26 may be selected as needed to optimize sealing characteristics.

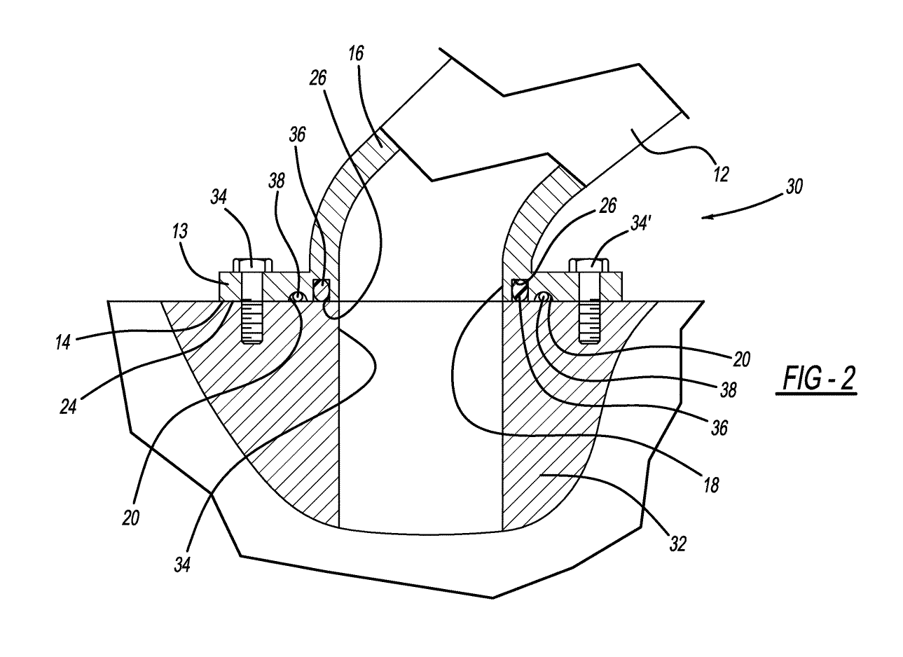

Referring to FIG. 2, a sectional view of an assembly of an intake manifold, a portion of a cylinder head having an intake port, and the dual intake manifold port gasket according to the disclosed inventive concept is illustrated generally as 30. In addition to the intake manifold 10, a portion of a cylinder head 32 having an intake port 34 is illustrated. The intake manifold 10 is attached to the cylinder head 32 by mechanical fasteners, such as by a pair of spaced apart bolts 34 and 34′ that are positioned through apertures formed in the attachment flange 13 and are attached to the cylinder head 32 by threading.

Also illustrated in FIG. 2 are spaced apart seals that include a relatively compressible inner air pressure seal 36 and an outer barrier seal 38. The inner air pressure seal 36 is positioned in each of the grooves 20, 20′ and 20″. The inner air pressure seal 36 is composed of a relatively inexpensive, readily compressible material such as rubber. The inner air pressure seal 36 may be extruded. Preferably but not exclusively, the extruded rubber may be silicone. So placed, the inner air pressure seal 36 provides an initial barrier to passage of fuel. Formed from silicone rubber, the inner air pressure seal 36 provides an effective, leak-proof seal that performs well at lower operating temperatures. Each of the inner air pressure seals 36 may be independent of one another as illustrated in FIG. 1 or may be attached to one another. Because of its compressibility, the inner air pressure seal 36 is squeezed between the intake manifold 10 and the cylinder head 32 on assembly thereby forming an airtight seal.

The outer barrier seal 38 is composed of a very different material compared with the material of the inner air pressure seal 36. Particularly, the outer barrier seal 38 is an in-place, hydrocarbon barrier that provides the final seal between the inner air pressure seal 36 and the atmosphere. The outer barrier seal 38 is preferably composed of a fluoroplastic or a fluororubber that has a relatively high fluorine content that provides minimal fuel permeation. A preferred composition for the outer barrier seal 38 is selected from one of the family of FKM high fluorine elastomers. Preferred, non-limiting examples among this group are FKM-A, an elastomer containing 66.0% fluorine and demonstrating a fuel permeation rate of 35 g-mm/m²/day, FKM-B, an elastomer containing 68.5% fluorine and demonstrating a fuel permeation rate of 12 g-mm/m²/day, and FKM-G, an elastomer containing 70.0% fluorine and demonstrating a fuel permeation rate of 3 g-mm/m²/day. Because increased fluorine content directly relates to improved permeation resistance (as well as to improved general chemical resistance), elastomers having high fluorine contents are preferred. Of this group, bisphenol-cured elastomers are preferred over peroxide-cured elastomers.

Compressibility of the outer barrier seal 38 is not required as in the case of the inner air pressure seal 36. Instead, it is only necessary that the outer barrier seal 38 form a contact between the intake manifold 10 and the cylinder head 32 on assembly to provide an effective hydrocarbon barrier.

Before assembling the intake manifold 10 to the cylinder head 32, the grooves 20, 20′ and 20″ are over-filled with the silicone seal that forms the inner air pressure seal 36. The outer barrier seal 38 is also positioned in the outer groove 26. The intake manifold 10 is thereafter fitted against the cylinder head 32 and the fasteners 34 and 34′ are inserted by threading until the proper amount of torque is achieved.

The relatively inexpensive inner air pressure seal 36, being preferably composed of silicone rubber, provides an effective leak-proof seal that operates well at lower engine operating temperatures. Because of its low cost, a generous amount of the material can be used. On the other hand, the relatively high cost outer barrier seal 38, formed from a high fluorine elastomer such as FKM, does not perform particularly well at low engine operating temperatures but provides an excellent hydrocarbon barrier. Working in conjunction with the relatively inexpensive inner air pressure seal 36 formed from silicone rubber, the outer barrier seal 38 formed from a relatively expensive high fluorine elastomer is provided in a relatively small quantity, thus reducing cost of the gasket arrangement without compromising effectiveness. With the inner air pressure seal 36 providing good seal qualities at low temperatures and the outer barrier seal 38 providing excellent hydrocarbon permeation-resistant properties, the two seals compliment one another and, together, provide a solution to the need to provide a good seal between the intake manifold and the cylinder head of an internal combustion engine across a wide range of temperatures at a low cost. The outer barrier seal 38 may be attached to one or more of the inner air pressure seals 36.

The disclosed invention as set forth above overcomes the challenges faced by known arrangements for providing a low-cost sealing arrangement that minimizes the escape of fuel from the joint between the intake manifold and the cylinder head. However, one skilled in the art will readily recognize from such discussion, and from the accompanying drawings and claims that various changes, modifications and variations can be made therein without departing from the true spirit and fair scope of the invention as defined by the following claims.

1. A system for sealing a cylinder head of an internal combustion engine and an intake manifold having runner openings, the system comprising:
an individual runner groove formed around each intake manifold runner opening forming plural of runner grooves;
a non-fluorinated gasket for relatively low engine temperature operation in each of said plurality of runner grooves;
a collective runner groove formed around and spaced apart from said plural runner grooves; and
a fluorinated hydrocarbon barrier gasket in said collective runner groove.

2. The system for sealing a cylinder head and an intake manifold having runner openings of claim 1 wherein non-fluorinated gasket material is an extruded rubber.

3. The system for sealing a cylinder head and an intake manifold having runner openings of claim 2 wherein said extruded rubber is silicone rubber.

4. The system for sealing a cylinder head and an intake manifold having runner openings of claim 1 wherein said fluorinated gasket is a fluorine elastomer.

5. The system for sealing a cylinder head and an intake manifold having runner openings of claim 4 wherein said fluorine elastomer has a fluorine content of at least 66.0%.

6. The system for sealing a cylinder head and an intake manifold having runner openings of claim 5 wherein said fluorine elastomer is a bisphenol-cured elastomer.

7. A gasket arrangement for use between the cylinder head of an internal combustion engine and an intake manifold having runner openings, the arrangement comprising:
an individual runner groove formed around each manifold runner opening forming plural runner grooves;
a collective runner groove formed around and spaced apart from said plural runner grooves;
a solid fluorine elastomer gasket in one of said individual runner grooves or in said collective runner groove; and
a silicone rubber gasket in the other of said individual runner grooves or in said collective runner groove.

8. The system for sealing a cylinder head and an intake manifold having runner openings of claim 7 wherein said silicone rubber gasket is extruded.

9. The system for sealing a cylinder head and an intake manifold having runner openings of claim 7 wherein said fluorine elastomer gasket has a fluorine content of at least 66.0%.

10. The system for sealing a cylinder head and an intake manifold having runner openings of claim 9 wherein said fluorine elastomer is a bisphenol-cured elastomer.

11. The system for sealing a cylinder head and an intake manifold having runner openings of claim 7 wherein said fluorine elastomer gasket is composed of a relatively incompressible fluorine elastomer.

12. A system for sealing a cylinder head of an internal combustion engine and an intake manifold having runner openings, the system comprising:
an individual runner groove formed around each runner opening in the intake manifold forming a plurality of runner grooves;
a sealing gasket material placed in each of said plurality of runner grooves;
a collective runner groove formed around and spaced apart from said plurality of runner grooves; and
a hydrocarbon barrier gasket material placed in said collective runner groove.

13. The system for sealing a cylinder head and an intake manifold having runner openings of claim 12 wherein said sealing gasket material provides an effective seal at low engine operating temperatures.

14. The system for sealing a cylinder head and an intake manifold having runner openings of claim 12 wherein said sealing gasket material is a compressible extruded rubber.

15. The system for sealing a cylinder head and an intake manifold having runner openings of claim 14 wherein said compressible extruded rubber is silicone rubber.

16. The system for sealing a cylinder head and an intake manifold having runner openings of claim 14 wherein said compressible extruded rubber has an operating temperature range of about −75° C. to about 225° C.

17. The system for sealing a cylinder head and an intake manifold having runner openings of claim 12 wherein said barrier gasket material has an operating temperature range of about −25° C. to about 250° C.

18. The system for sealing a cylinder head and an intake manifold having runner openings of claim 12 wherein said barrier gasket material is a fluorine elastomer.

19. The system for sealing a cylinder head and an intake manifold having runner openings of claim 18 wherein said fluorine elastomer has a fluorine content of at least 66.0%.

20. The system for sealing a cylinder head and an intake manifold having runner openings of claim 19 wherein said fluorine elastomer is a bisphenol-cured elastomer.
